(19) United States
(12) Patent Application Publication
(10) Pub. No.: US 2009/0101034 A1
(43) Pub. Date: Apr. 23, 2009

(54) CREATING A UNIFORM IMAGING SURFACE

(76) Inventor: David Aviel, Tel Mond (IL)

Correspondence Address: David A. Novais, Patent Legal Staff;Eastman Kodak Company, 343 State Street, Rochester, NY, 14650-2201, US

(21) Appl. No.: 11/873,502

(22) Filed: Oct. 17, 2007

(51) Int. Cl. B41N 3/00

(52) U.S. Cl. 101/463.1

(57) ABSTRACT

An apparatus for creating a uniform imaging surface on a flexographic plate or flexographic sleeve (14) mounted on a drum (16) and comprises a light source; a transparent drum (22); and a lens system (12) for focusing a beam from the light source through the transparent drum onto the flexographic plate or sleeve.

### FIELD OF THE INVENTION

This present invention relates to an apparatus and methods for creating a uniform imaging surface by fastening flexographic printing plates mounted on a drum.

### BACKGROUND OF THE INVENTION

Flexographic printing plates are imaged on special optical-mechanical plate makers. The flexographic plate or sleeve, usually made from rubber based material, is placed on a drum for imaging. Due to its flexible nature, the flexographic plate, when mounted on the imaging drum 16 as illustrated in FIG. 1, has a non-uniform plate surface. This fact introduces a major disadvantage, since it requires an optical imaging system with auto focus means to overcome the non-uniformity of the imaging plate.

Referring to FIG. 1, the laser source 10 emits a laser beam 11 via the attached waveguide 13. Laser beam 11 enters lens system 12, and impinges on flexographic printing plate 14. Often laser beam 11 will be out of focus on flexographic printing plate 14 forming out of focus dots. This requires refocusing laser beam 11. The focusing is achieved by changing the position of an optical element in the optical path. Common practice today is to change the position of the lens system 12, thus changing the focus of beam 11 on the printing plate, thereby forming a well balanced dot on the surface of the printing plate.

The auto focus method described above dynamically adjusts the optical path to track the surface of the flexographic printing plate 14. The changing working distance results in sophisticated optical systems, which are needed to compensate for the total indicated runout (TIR), for mis-alignment between drum rotation axis and head motion axis and plate surface non uniformity. This is costly, both in terms of exposure time as well as additional cost for equipping the system with auto focus means.

### SUMMARY OF THE INVENTION

Briefly, according to one aspect of the present invention an apparatus for creating a uniform imaging surface on a flexographic plate or flexographic sleeve mounted on a drum and comprises a light source; a transparent drum; and a lens system for focusing a beam from the light source through the transparent drum onto the flexographic plate or sleeve.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

FIG. 1 is a schematic illustrating a prior art flexographic imaging system equipped with auto focus means.

FIG. 2 is a schematic illustrating a flexographic imaging system equipped with a transparent drum to form a uniform imaging surface on a flexographic plate.

FIG. 3 is a schematic illustrating a flexographic imaging system equipped with a hollow transparent drum to form a uniform imaging surface on a flexographic plate.

FIG. 4 is a schematic illustrating a perspective view of a flexographic plate solid plate fastener configuration.

FIG. 5 is a schematic illustrating a perspective view of another flexographic plate hollow plate fastener configuration.

FIG. 6 is a schematic illustrating top view of a hollow drum with a trapezoid cross section.

### DETAILED DESCRIPTION OF THE INVENTION

The present invention describes a plate fastening system, which brings uniformity to the plate surface prior to imaging, thus removing the need for expensive auto focusing means.

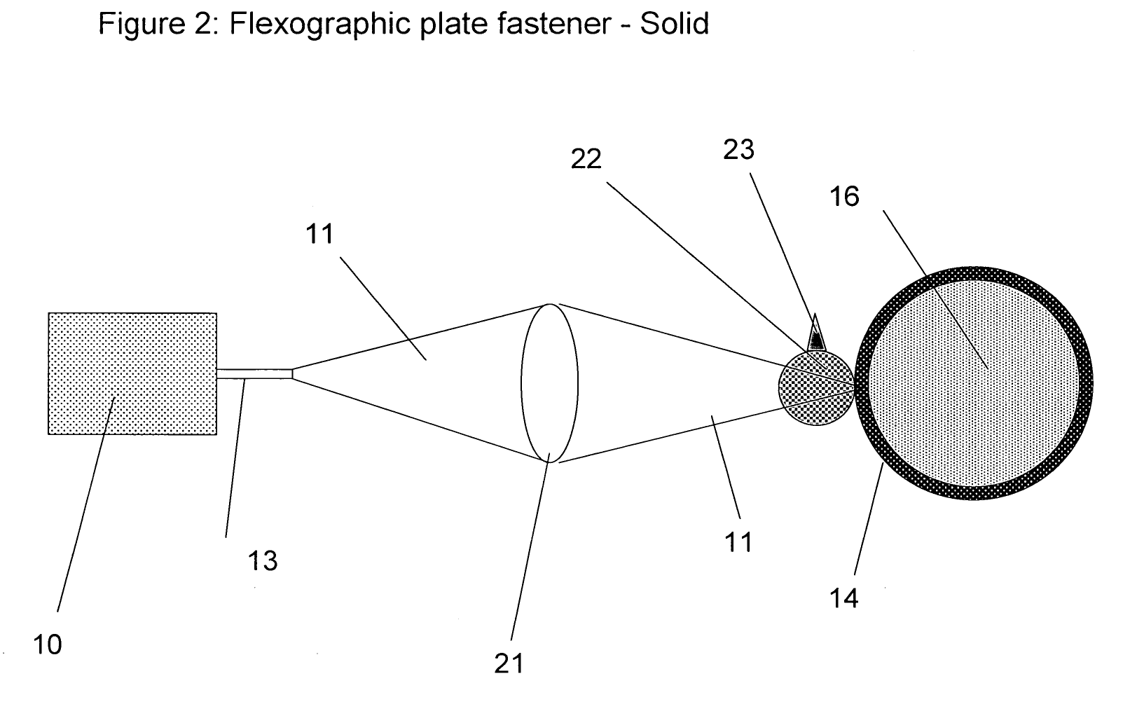

Referring to FIG. 2, the present invention has a fixed laser source 10 which directs laser beam 11 through a lens 21. The beam will impinge on a spot on flexographic printing plate 14. Laser beam 11, before reaching flexographic printing plate 14, which is mounted on imaging drum 16, passes through fastening transparent drum 22.

The fastening transparent drum 22 is mounted such that a fixed distance is maintained between a surface of the imaging drum 16 and an axis transparent drum 16. When imaging drum 16 and fastening transparent drum 22 are rotating, fastening transparent drum 22 applies pressure on flexographic printing plate 14 approximately equal to the pressure that a printing press would apply to the printing plate. The result is generation of a uniform surface on the imaging area of flexographic printing plate 14, thus removing the need to use auto focus means for each line of imaging. The transparent material used for fastening transparent drum 22 enables a laser beam 11 to pass through the fastening transparent drum 22, prior to impinging on flexographic printing plate 14 for imaging.

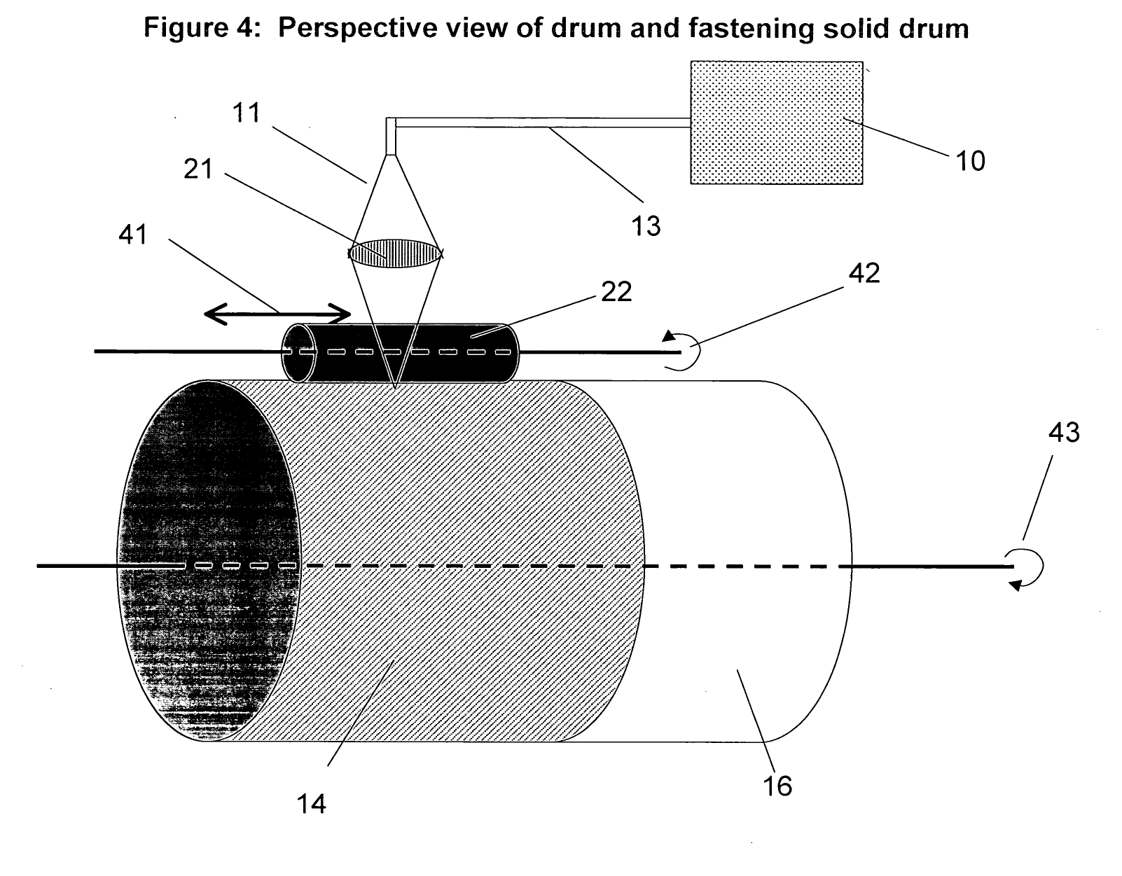

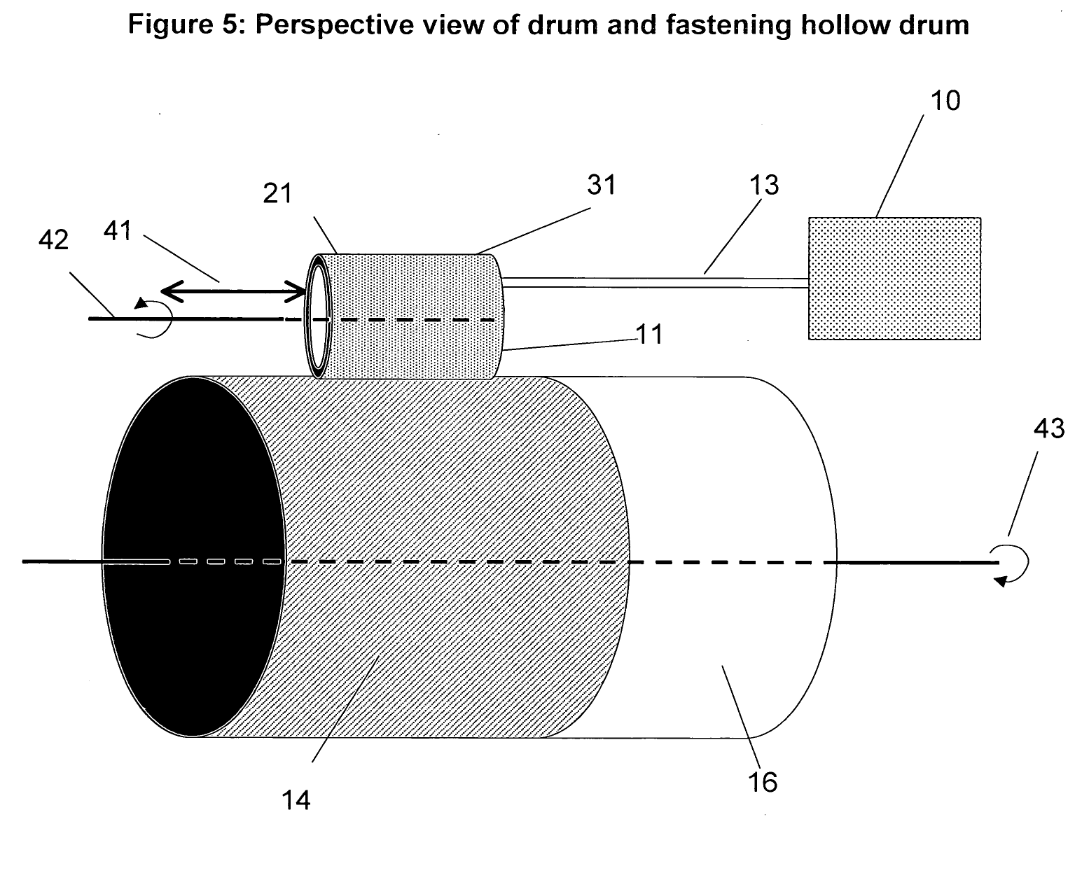

In one embodiment, the fastening transparent drum 22 (or fastening hollow transparent drum 31) is shorter than imaging drum 16. In order to fasten the entire length of flexographic printing plate 14, which is mounted on imaging drum 16, fastening transparent drum 22 is moved along imaging drum 16 in fastening drum moving direction 41 as is illustrated in FIGS. 4 and 5. Imaging drum 16 and fastening transparent drum 22 (or fastening hollow transparent drum 31) rotate around parallel imaging drum rotation axis 43 and fastening drum rotation axis 42 respectively.

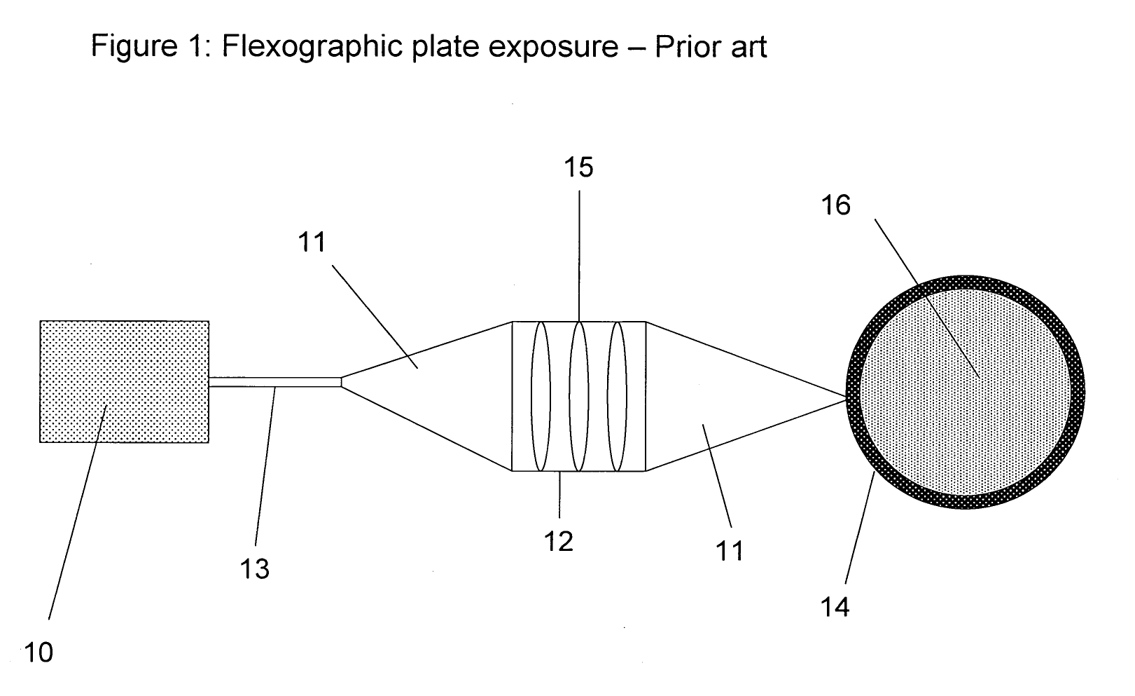

Fastening drum cleaning element 23, shown in FIG. 1, attached to fastening transparent drum 22, and comprises a liquid, for example water, supply and a wiping tissue, for example a brush. Fastening drum cleaning element 23 applies water on fastening transparent drum 22 while fastening transparent drum 22 rotates. In addition, it uses a brush to wipe accumulated plate debris on fastening transparent drum 22. The cleaning process serves two purposes, debris removal and cleaning fastening transparent drum 22. The constant cleaning of fastening transparent drum 22 is important in order to maintain its transparency for achieving optimal laser radiation through fastening transparent drum 22.

In another embodiment drum 22 can be built from gradient index lenses (GRIN), which will allow fastening transparent drum 22 to function as a lens in addition to its fastening function. The gradient index lenses will focus the light through a precisely controlled radial variation of the lens material's index of refraction from the optical axis to the edge of the lens, or fastening transparent drum 22.

Engraving is done while the flexographic printing plate 14 is under pressure similar to the pressure applied on the plate by the printing press. This means that plate engraving is performed under conditions similar to when the plate is mounted on the printing press. This causes flexographic printing plate 14 dimensions be very close to the plate dimensions when mounted on the printing press, which yields a more accurate compensation for dot gain and variations in dot gain due to plate non-uniformity and plate drum run-out.

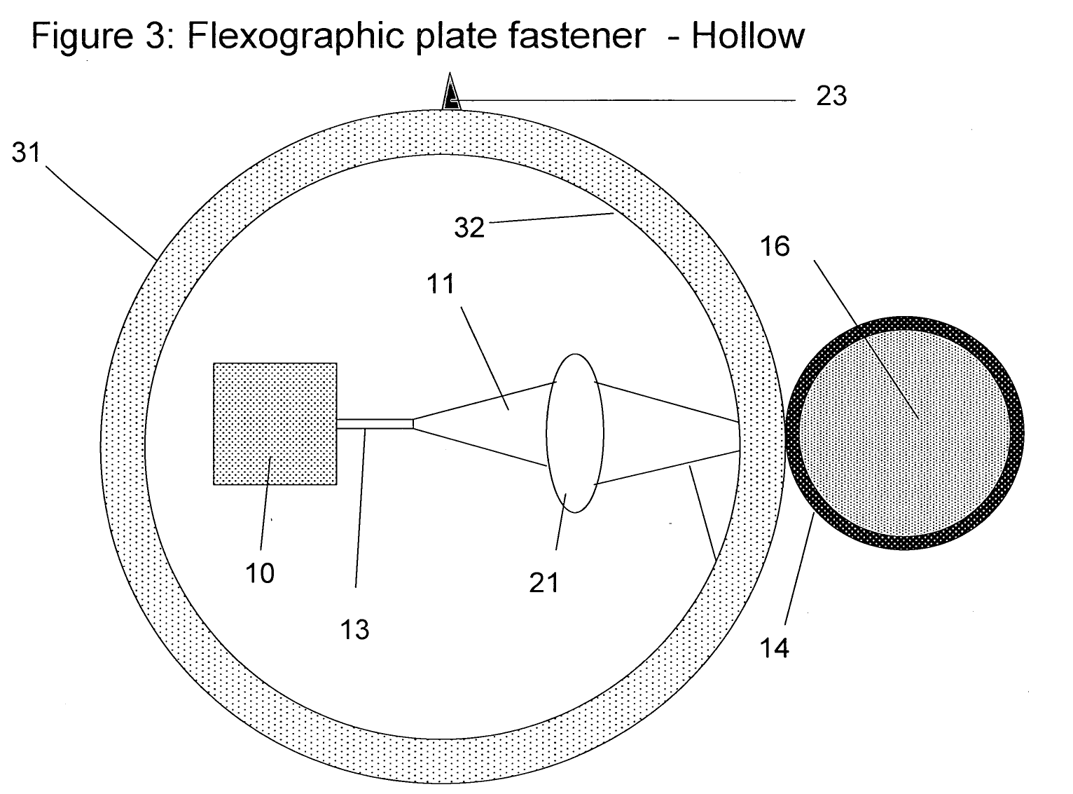

In another embodiment of this invention, a hollow fastening transparent drum 31 is used, as is illustrated in FIG. 3. The optical elements 10, 11, 13 and 21 are connected through the hollow volume of the hollow fastening transparent drum 31. This embodiment has several advantages. The internal drum surface 32 of the fastening hollow transparent drum 31, does not pick up dirt, generated by the plate debris. It is also less prone for scratches, and thus can better maintain the optical qualities of the hollow fastening transparent drum 31. Therefore the inner drum surface 32 can be prepared in various forms such as convex or concave to equip the hollow fastening transparent drum 31 with required optical features to act as a lens.

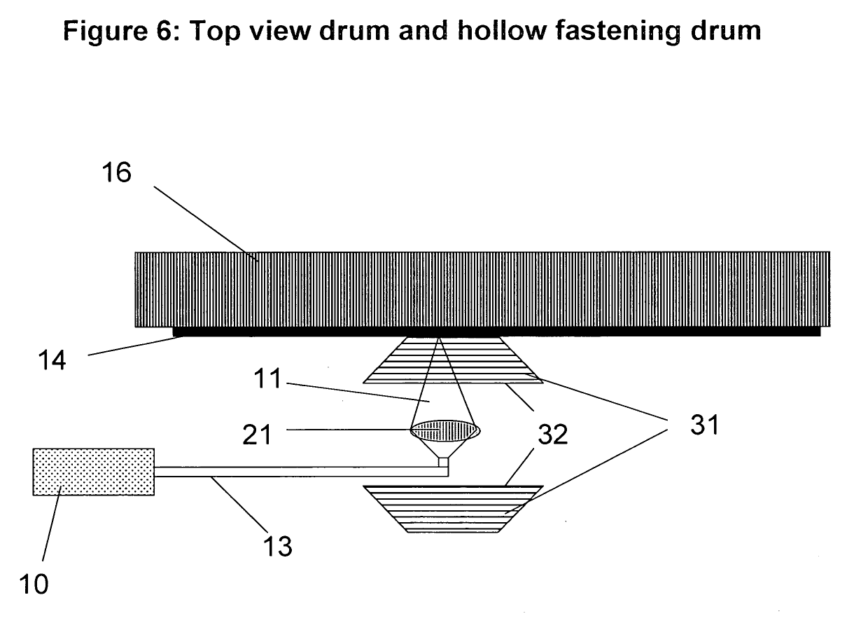

The required thickness of the hollow fastening transparent drum 31 may be on the order of the size of the imaged plate area, so that the imaged area on the plate is sufficiently pressed to achieve a uniform plate surface. In addition the cross section of the hollow fastening transparent drum 31 may be square, circular, trapezoid, or any other geometrical shape. FIG. 6 shows a cross section of a trapezoid shape of fastening hollow transparent drum 31.

The invention has been described in detail with particular reference to certain preferred embodiments thereof, but it will be understood that variations and modifications can be effected within the scope of the invention.

### PARTS LIST

10 laser source
11 laser beam
12 lens system
13 waveguide
14 flexographic printing plate
16 imaging drum
21 lens
22 fastening transparent drum
23 fastening drum cleaning element
31 hollow fastening transparent drum
32 internal drum surface
41 fastening drum moving direction
42 fastening drum rotation axis
43 imaging drum rotation axis

1. An apparatus for creating a uniform imaging surface on a flexographic plate or flexographic sleeve mounted on a drum or comprising:
a light source;
a transparent drum; and
a lens system for focusing a beam from the light source through the transparent drum onto the flexographic plate or sleeve.

2. The apparatus of claim 1 wherein a drum cleaning element cleans the transparent drum.

3. The apparatus of claim 2 wherein the drum cleaning element comprises a liquid supply and a brush for removing debris from the transparent drum.

4. The apparatus of claim 1 wherein the transparent drum comprises a gradient index lens.

5. The apparatus of claim 1 wherein the transparent drum comprises a solid optical material.

6. The apparatus of claim 1 wherein the transparent drum hollow and is comprised of an optical material.

7. The apparatus of claim 1 wherein the drum and the transparent drum rotate around parallel axes.

8. The apparatus of claim 1 wherein the transparent drum applies the uniform pressure to the flexographic plate or sleeve.

9. The apparatus of claim 1 wherein the transparent drum has optical power in a beam direction.

10. A method for creating a uniform imaging surface on a flexographic plate or a flexographic sleeve mounted on a drum comprising:
producing an imaging beam;
compressing the imaging surface of the flexographic plate with a transparent drum; and
focusing the imaging beam on the imaging surface through the transparent.

11. An apparatus for creating a uniform imaging surface on a flexographic plate or flexographic sleeve mounted on a drum or comprising:
a hollow transparent drum, wherein the hollow transparent drum maintains a uniform pressure on the flexographic plate or sleeve;
a light source providing a beam of light to an interior portion of the hollow transparent drum; and
a lens system for focusing the beam from the light source through the hollow transparent drum onto the imaging surface of the flexographic plate or sleeve.

12. The apparatus of claim 11 wherein a cross section of the hollow transparent drum is selected from a group comprised of a square, a circle, or a trapezoid.
